(19) United States
(12) Patent Application Publication
(10) Pub. No.: US 2023/0274262 A1
(43) Pub. Date: Aug. 31, 2023

(54) SYSTEM AND METHOD FOR BETTER UTILIZATION OF POWER CONSUMPTION IN BLOCKCHAIN SYSTEM BY VALIDATING DIGITAL CURRENCY TRANSACTIONS WITH MINIMAL COMPUTING RESOURCES

(71) Applicant: International Institute of Information Technology, Hyderabad, Hyderabad (IN)

(72) Inventors: Sujit Prakash Gujar, Hyderabad (IN); Yash Chaurasia, Hyderabad (IN); Visvesh Subramanian, Hyderabad (IN)

(21) Appl. No.: 18/115,693

(22) Filed: Feb. 28, 2023

(30) Foreign Application Priority Data
Feb. 28, 2022 (IN) 202241010861

(51) Int. Cl. G06Q 20/36; G06Q 20/40

(52) U.S. Cl. CPC G06Q 20/3678; G06Q 20/3674; G06Q 20/4012

(57) ABSTRACT

A system for better utilization of power consumption of a computing network in at least one blockchain system by validating digital currency transactions with minimal computing resources. The system is configured to (i) communicate at least one problem with a difficulty calculation specification using a centralized server, (ii) create a problem mempool to broadcast the at least one problem with the difficulty calculation specification, (iii) create a transaction mempool to enable the at least one miner to select the at least one transaction, (iv) validate a solution that corresponds to the at least one problem, (v) verify a block associated with the selected problem with a validated solution as proof of work and (vi) determine a problem fee for the at least one miner for the solved problem when the block associated is verified.

### CROSS-REFERENCE TO PRIOR-FILED PATENT APPLICATIONS

This application claims priority from the Indian provisional application no. 202241010861 filed on Feb. 28, 2022, which is herein incorporated by reference.

### BACKGROUND

### Technical Field

The present disclosure generally relates to blockchain systems, more specifically, the present disclosure relates to a system and a method for better utilization of power consumption of a computing network in at least one blockchain system by validating digital currency transactions with minimal computing resources.

### Description of the Related Art

Blockchain is a distributed ledger technology that is shared among nodes of a peer-to-peer network and stores data in a distributed chain of blocks. Each block contains a hash of a previous block, thereby prohibiting any changes or edits in the previous blocks once newer blocks are published. Bitcoin is a digital currency, a decentralized system that records transactions in a distributed ledger of blockchain technology. Bitcoin uses Proof-of-Work (PoW) as a consensus mechanism in which members of the peer-to-peer network (hereinafter miners) compete to append blocks (adding transactions) and earn mining rewards to the distributed ledger, miners have to solve a computationally intensive cryptographic puzzled.

One of the key factors in PoW is that the probability of a miner mining a block is equal to a fraction of the entire network's computational power held by them. Consequently, miners keep investing in these resources as long as it is profitable to do so. Apart from establishing consensus in Bitcoin's network, the solutions to these puzzles have no use. These two factors combined mean that a lot of electricity (120 Terawatt-hour (TWh) per year and hardware resources (91*10¹⁸ Hashes per second) are spent just to mine Bitcoin, with no other useful work done. The total electricity used in mining bitcoin may exceed the electricity consumption of many countries, which has been a major criticism of Bitcoin. This criticism also had been one of the major reasons for the crypto crash in May 2021, reducing the public trust in all cryptocurrencies in general, even those not relying on PoW for consensus.

Some existing cryptocurrency approaches require miners to produce a Cunningham chain or bi-twin chain of some length decided by the computation power of the network as proof-of-work. Though these chains of primes generated as PoW are available to everyone for use, their practical applications are limited.

Some existing approaches replace proof of work with proof of retrievability which ensures that participating nodes store a very large data set (such as a library of books) in a distributed manner. Hence, its practical applications are limited.

Some existing approaches propose optimization problems, machine learning problems or nucleic acid sequence search problems as the proof of work to accomplish additional useful work in conjunction with blockchain mining. However, those problems are not progress-free and may not give a proportional advantage to the miners. For example, there are 99 miners where 98 miners have 1% computing power and the remaining one miner has 2% computing power, the miner with 2% computing power will win almost 100/6 of the time if the problem is not progress-free. For brevity, a miner who has a high-performance computer may receive a reward all the time.

Therefore, there is a need to address the aforementioned technical drawbacks in existing technologies in mining blockchains to accomplish practically useful work as proof of work (PoW) while simultaneously achieving consensus in the blockchain.

### SUMMARY

Embodiments herein provide a system for better utilization of power consumption of a computing network in at least one blockchain system by validating digital currency transactions with minimal computing resources. The system includes a memory and a processor. The processor is configured to (i) communicate at least one problem with a difficulty calculation specification using a centralized server, (ii) create a problem mempool to broadcast the at least one problem with the difficulty calculation specification, (iii) create a transaction mempool to enable the at least one miner to select the at least one transaction, (iv) validate a solution that corresponds to the at least one problem by checking if the at least one problem is solved by at least one miner using a hash, (v) verify a block associated with the selected problem with a validated solution using the hash of a previous block of the blockchain as a proof of work, and (vi) determine a problem fee for the at least one miner for the solved problem when the block associated is verified. The centralized server communicates at least one transaction that corresponds to at least one miner. The at least one problem is entered into the problem mempool once a problem is registered in a problem merkle tree. The selected problem is communicated to the at least one miner using at least one of the centralized server, a problem mempool or a transactional mempool.

In some embodiments, the centralized server is utilized for a centralized blockchain system to communicate the at least one problem with the difficulty calculation specification.

In some embodiments, the problem mempool and the transaction mempool are created for a decentralized blockchain system to broadcast the at least one problem with the difficulty calculation specification.

In some embodiments, the transaction mempool includes valid pending transactions that are added to be in the blockchain.

In some embodiments, the at least one problem are cryptographic puzzles that are communicated to the at least one miner using the centralized server by at least one puzzler.

Each problem includes a problem description, a timestamp, a difficulty level of a problem, a problem fee, and a solution description.

In some embodiments, the system is communicatively connected with one or more computing devices that are associated with the at least one miner to solve the at least one problem. Each computing device stores the blockchain.

In some embodiments, each block of the blockchain includes at least one of a block header or a block body. The block header includes at least one of a hash of a previous data block, Merkle root of transactions, a Merkle root of a new problem timestamp, a nonce, a version, or a difficulty, and a hash of a problem solved. The block body includes at least one transaction in Merkle tree, or the problem that is solved by the at least one miner of the one or more miners.

In some embodiments, the at least one miner solves a cryptographic puzzle as the proof of the work in an absence of problems in the problem mempool to solve.

In some embodiments, the problems in the problem mempool include at least one of (i) equiprobable solution space where inputs given are equally to produce a valid solution, which is to be maintained progress-freeness because if a solution space is skewed, the at least one miner is tried out promising inputs first, (ii) inexhaustible solution space where the blockchain does not run out of problems to solve, (iii) non-algorithmically generated or (iv) application-specific integrated circuit (ASIC) resistance that enables a general-purpose computer too to solve the problem.

In some embodiments, the at least one miner publishes the solution as a proof of work block for the at least one problem that is selected and solved to claim the problem fee.

In another aspect, a method for better utilization of power consumption of a computing network in at least one blockchain system by validating digital currency transactions with minimal computing resources is provided. The method includes (i) communicating at least one problem with a difficulty calculation specification using a centralized server, (ii) creating a problem mempool to broadcast the at least one problem with the difficulty calculation specification, (iii) creating a transaction mempool to enable the at least one miner to select the at least one transaction, (iv) validating a solution that corresponds to the at least one problem by checking if the at least one problem is solved by at least one miner using a hash, (v) verifying a block associated with the selected problem with a validated solution using the hash of a previous block of the blockchain as proof of work and (vi) determining a problem fee for the at least one miner for the solved problem when the block associated is verified. The centralized server communicates at least one transaction that corresponds to at least one miner. The at least one problem is entered into the problem mempool once a problem is registered in a problem merkle tree. The selected problem is communicated to the at least one miner using at least one of the centralized server, a problem mempool, or a transactional mempool.

In some embodiments, the method includes utilizing the centralized server for a centralized blockchain system to communicate the at least one problem with the difficulty calculation specification.

In some embodiments, the method includes creating the problem mempool and the transaction mempool for a decentralized blockchain system to broadcast the at least one problem with the difficulty calculation specification. The transaction mempool includes valid pending transactions that are added to be in the blockchain.

In some embodiments, the method includes communicating at least one problem are cryptographic puzzles to the at least one miner using the centralized server by at least one puzzler. Each problem includes a problem description, a timestamp, a difficulty level of a problem, a problem fee, and a solution description.

In some embodiments, the method includes (a) solving a cryptographic puzzle by the at least one miner as the proof of the work in an absence of problems in the problem mempool to solve and (b) publishing the solution by the at least one miner as a proof of work block for the at least one problem that is selected and solved to claim the problem fee.

In another aspect, there is provided one or more non-transitory computer-readable storage mediums storing the one or more sequences of instructions, which when executed by one or more processors, further causes a method for better utilization of power consumption of a computing network in at least one blockchain system by validating digital currency transactions with minimal computing resources. The method includes (i) communicating at least one problem with a difficulty calculation specification using a centralized server, (ii) creating a problem mempool to broadcast the at least one problem with the difficulty calculation specification, (iii) creating a transaction mempool to enable the at least one miner to select the at least one transaction, (iv) validating a solution that corresponds to the at least one problem by checking if the at least one problem is solved by at least one miner using a hash, (v) verifying a block associated with the selected problem with a validated solution using the hash of a previous block of the blockchain as proof of work and (vi) determining a problem fee for the at least one miner for the solved problem when the block associated is verified. The centralized server communicates at least one transaction that corresponds to at least one miner. The at least one problem is entered into the problem mempool once a problem is registered in a problem merkle tree. The selected problem is communicated to the at least one miner using at least one of the centralized server, a problem mempool, or a transactional mempool.

In some embodiments, the one or more non-transitory computer-readable storage mediums storing the one or more sequences of instructions of utilizing the centralized server for a centralized blockchain system to communicate the at least one problem with the difficulty calculation specification.

In some embodiments, the one or more non-transitory computer-readable storage mediums storing the one or more sequences of instructions of creating the problem mempool and the transaction mempool for a decentralized blockchain system to broadcast the at least one problem with the difficulty calculation specification. The transaction mempool includes valid pending transactions that are added to be in the blockchain.

In some embodiments, the one or more non-transitory computer-readable storage mediums storing the one or more sequences of instructions of communicating at least one problem are cryptographic puzzles to the at least one miner using the centralized server by at least one puzzler. Each problem includes a problem description, a timestamp, a difficulty level of a problem, a problem fee and a solution description.

In some embodiments, the one or more non-transitory computer-readable storage mediums storing the one or more sequences of instructions of (i) solving a cryptographic puzzle by the at least one miners as the proof of the work in an absence of problems in the problem mempool to solve; and (ii) publishing the solution by the at least one miner as a proof of work block for the at least one problem that is selected and solved to claim the problem fee.

The embodiments herein provide practically useful problems along with problem fees to miners for solving, thereafter use the solved problems as a proof of work (PoW) for creating a new block in a blockchain system. Puzzlers benefit as they can get their problem solved by the blockchain rather than some other business organization. Crowdsourcing organizations may get relief from a pressure to be transparent and prove correctness at all the extra steps. The electricity is spent doing something useful unlike bitcoin, and thus is more environment friendly.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed descriptions with reference to the drawings, in which:

FIG. 1 is a block diagram that illustrates a system for better utilization of power consumption of a computing network in at least one blockchain system by validating digital currency transactions with minimal computing resources according to some embodiments herein;

FIG. 2 illustrates a decentralized blockchain system for providing practically useful proof of work in blockchain mining according to some embodiments herein;

FIG. 3 illustrates a centralized blockchain system for providing practically useful proof of work in blockchain mining according to some embodiments herein;

FIG. 4 is a block diagram that illustrates one or more modules of each of the computing devices of the decentralized blockchain system of FIG. 2 according to some embodiments herein;

FIG. 5 is a block diagram that illustrates one or more modules of each of the computing devices of the centralized blockchain system of FIG. 3 according to some embodiments herein;

FIG. 6 illustrates an exemplary block of a blockchain network according to some embodiments herein;

FIG. 7 illustrates a method for providing practically useful proof of work in a decentralized system for blockchain mining according to some embodiments herein;

FIG. 8 illustrates a method for providing practically useful proof of work in a centralized system for blockchain mining according to some embodiments herein;

FIG. 9 illustrates a method for better utilization of power consumption of a computing network in at least one blockchain system by validating digital currency transactions with minimal computing resources according to some embodiments herein; and

FIG. 10 is a schematic diagram of a computer architecture of a computing device, in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

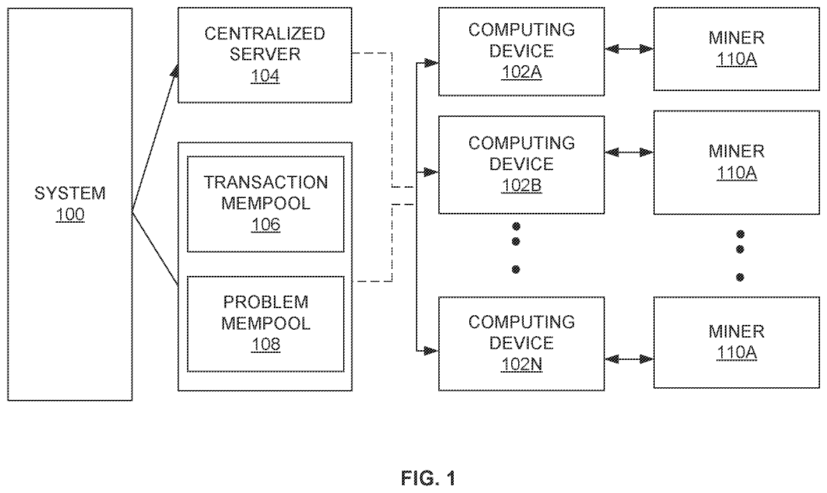

As mentioned, there remains a need for an approach to using computational power of a computing device into a useful work in addition to achieve consensus in a blockchain system. The embodiments herein achieve this by providing a system and method that provide practically useful problems along with problem fees to miners for solving, thereafter using the solved problems as a proof of work (PoW) for creating a new block in a blockchain system. Referring now to the drawings and more particularly to FIGS. 1 through 10, where similar reference characters denote corresponding features consistently throughout the figures, there are shown preferred embodiments.

FIG. 1 is a block diagram that illustrates a system 100 for better utilization of power consumption of a computing network in at least one blockchain system by validating digital currency transactions with minimal computing resources according to an embodiment herein. The block diagram includes the system 100, one or more computing devices 102A-N, a centralized server 104, a transaction mempool 106, a problem mempool 108 and one or more miners 110A-N. In some embodiments, the one or more miners 110A-N are associated with one or more computing devices 102A-N. In some embodiments, the one or more computing devices 102A-N include but not limited to a personal computer, a laptop, a tab or a mobile. In some embodiments, the problem mempool 108 and the transaction mempool 106 are created for a decentralized blockchain system to broadcast at least one problem with a difficulty calculation specification.

The system 100 communicates at least one problem with a difficult calculation specification using a centralized server 104. In some embodiments, the centralized server 104 communicates at least one transaction that corresponds to at least one miner. In some embodiments, the system 100 creates at least one of the transaction mempool 106 or the problem mempool 108. The problem mempool 108 may be defined as an organized queue of problems that are are stored and maintained. The problem mempool 108 broadcasts the at least one problem with the difficulty calculation specification. In some embodiments, the at least one problem is entered into the problem mempool once a problem is registered in a problem Merkle tree. The transaction mempool 106 may be defined as an organized queue of transactions that are stored and maintained. The transaction mempool 106 enables the at least one miner to select the at least one transaction.

The system 100 validates a solution that corresponds to the at least one problem by checking if the at least one problem is solved by the one or more miners 110A-N using a hash. In some embodiments, the selected problem is communicated to the one or more miners 110A-N using at least one of the centralized server 104, the problem mempool 108, or the transactional mempool 106. The system 100 verifies a block associated with the selected problem with a validated solution using the hash of a previous block of the blockchain as proof of work. The system 100 determines a problem fee for the one or more miners 110A-N for the solved problem when the block associated is verified. In some embodiments, the centralized server 104 is utilized for a centralized blockchain system to communicate the at least one problem with the difficulty calculation specification. In some embodiments, the problem mempool 108 and the transaction mempool 106 are created for a decentralized blockchain system to broadcast the at least one problem with the difficulty calculation specification.

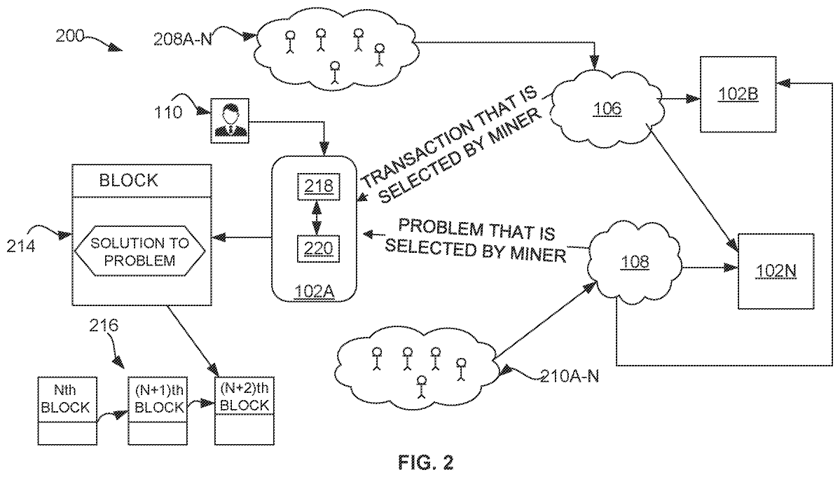

FIG. 2 illustrates a decentralized blockchain system 200 for providing practically useful proof of work in blockchain mining according to some embodiments herein. The decentralized blockchain system 200 includes of the one or more computing devices 102A-N, the transaction mempool 106, the problem mempool 108, and a blockchain 216. Each of the one or more computing devices 102A-N stores the blockchain 216 and associated problem with the difficulty calculation specification. The one or more computing devices 102A-N are communicatively connected with each other in a peer-to-peer network. The one or more computing devices 102A-N are associated with the one or more miners 110A-N. Each computing device 102A includes a memory and a processor that is configured to perform mining in the blockchain system 200. For example, the computing device 102A associated with the miner 110A includes a memory 218, and a processor 220. The one or more computing devices 102A-N may be a computer, a mobile terminal, or any dedicated electronic device with a computing ability to solve a proposed problem. The blockchain 216 includes one or more data blocks that are created by the one or more miners 110A-N after verifying each transaction and solution to a problem. The one or more data blocks is linked with each other. In some embodiments, each data block includes a block header and a block body. The block header may include a hash of a previous block, Merkle root of transactions, Merkle root of a new problem timestamp, nonce, version, and difficulty and hash of a problem solved. The block body may include transactions in Merkle tree, and a problem that is solved by a miner. All the transactions are included outside the block header of the block and arranged in the Merkle tree. The Merkle root is committed in the block header.

Transactions may be created by one or more users 208A-N of the peer-to peer network to describe financial transactions or to provide other types of information. The transactions may include inputs and outputs denoting the transfer of some units of digital currency with appropriate signatures. Typically, the inputs include signatures and public keys and the outputs include scripts depending on a usage. The transactions that are valid and generated by the one or more users 208A-N are relayed to other users or miners 110A-N via a network. The network may be a local area network (LAN), a wide area network (WAN), a public network, a private network, a proprietary network, a public telephone switched network (PSTN), the Internet, a wireless network, a virtual network, or any combination thereof. The transaction mempool 106 includes all valid pending transactions that are not included in the blockchain 216. The transactions in the transaction mempool 106 are to be confirmed by the other users.

The problem mempool 108 includes one or more problems that are proposed by one or more puzzlers 210A-N. The one or more puzzlers 210A-N may interchangeably denote a person and an electronic device. Each problem includes a problem description, a timestamp, a difficulty level of a problem, a problem fee, and a solution description. The one or more puzzlers 210A-N may be any individual or any organization. The one or more puzzlers 210A-N broadcasts the problem and once a block lists the problem in a problem Merkle tree, the problem enters the problem mempool 108. The problems may be non-algorithmically generated problems. The problems may be practical. The problems may be based on orthogonal vectors, 3SUM, or all-pairs shortest path problems. Once the difficulty of the problem is changed, older problems no longer remain valid. The problem mempool 108 includes valid problems that need to be solved by the one or more miners 110A-N.

The computing device 102A, then creates a new block 214 by (i) selecting any valid transaction that is generated by the one or more users 208A-N, from the transaction mempool 106 by the miner 110, (ii) accepting and publishing the selected transaction in the new block 214, (iii) selecting any problem from the problem mempool 108, (iv) solving the problem using the computing power of the computing device 102A as a proof of work, where the hash of a block header is used as an input for the problem to be solved, and (iv) broadcasting the new block 214 once the problem is solved to the other one or more miners 110A-N for verification. The miner 110A may select some transactions from the transaction mempool 106.

The miner 110 may then claim the problem fee based on the problem selected, from a puzzler and a transaction fee based on the transaction selected. The miner 110 may also receive a mining reward in addition to the problem fee and the transaction fee. The new block 214 is published or updated in the blockchain once the new block 214 is verified by other one or more miners 110A-N in the decentralized blockchain system 200.

In some embodiments, the miner 110 solves a cryptographic puzzle as the proof of work in an absence of problems in the problem mempool 106 to solve.

In one exemplary embodiment, let Sₛ be a set of all problem types Pᵢ satisfying certain conditions. Thus, Sₛ={P₁;P₂, . . . }. Note that Bitcoin's cryptographic puzzle, P_{b} ∈Sₛ. Let S∈Ss be a set of types of problems that may be proposed as a proof of work on the blockchain. Details regarding rewards how to characterize the difficulty of each problem type is pre-defined. The one or more puzzlers 210A-N may select a problem type Pᵢ and ask for a specific instance satisfying a current difficulty of the blockchain. For example, if a problem is defined by Primecoin Pₚ ∈S, a puzzler may ask for a bi-twin chain of a length determined by the difficulty. Then, a miner selects the problem and solves the problem. For example, to pick and solve a problem
1) Select Pᵢs where Pᵢ∈S;
(Pᵢs are problem types for which the miner has hardware to solve)
2) Refresh Problem Mempool( );
(gather problems for the current difficulty)
3) from problem mempool pick p∈Uᵢ Pᵢ;
4) do
5) h=H(block header);
6) if Solve(p; h) then
7) Publish Block( );
8) break( );
9) end
10) while New Block Published( )==false;
11) Update Blockchain( );

In an exemplary embodiment, the problem is vanity.onion uniform resource locator (URL) generating the problem. The miner 110 may use a similar technique for generating vanity addresses in bitcoin and other applications using a digital signature algorithm (DSA)-like scheme to generate addresses. The blockchain-generating vanity addresses for proof-of-work may be referred as Vanity Coin.

In another exemplary embodiment, a problem for the generation of vanity addresses is proposed by a puzzler where the puzzler specifies their acceptable addresses in a regex format. The difficulty of the regex expression can be calculated. Regex allows fine control over the difficulty. Instead of having a single difficulty in the blockchain specification, the blockchain gives a range of valid difficulties that the problem proposal may have. The puzzler picks a random number x0 and gives the value of y0=g\hat{ }(x₀) mod p in a problem proposal. Hash h of a block header, which also belongs to a private keyspace, is computed by a miner. y=y0*g^{h} is computed for h, and if y matches the regex R, the block may be published, or else, the miner tries a different nonce. Thus, y=g\hat{ }(x₀)*g^{h}=g\hat{ }(x₀+h). Therefore, the private key is x=x₀+h. The blockchain network only knows h while x₀ is known only to the puzzler. Thus, x is known only to the puzzler. If puzzler's.onion URL is generated, the one or more miners 110A-N and the users only know y, h, y0. To know the private key, an attacker needs to know x0+h such that y=g\hat{ }(x₀+h)=y0*g^{h}. Thus, to know the private key, the attacker needs to solve either y=g^{x} or y₀=g\hat{ }(x₀), i.e., solve a discrete log problem.

Thereafter, the one or more miners 110A-N and users may verify the block by: (i) verifying whether the difficulty of the regex R of the problem selected is within the current difficulty bounds of the blockchain, (ii) computing hash h of the block header, (iii) calculating y=y₀*g^{h}, (iv) checking if y matches R, (v) verifying transactions, Merkle tree, etc., (vi) any of the above fails, the block is considered invalid; else, the block is valid. Thus, the private key is x=x₀+h and the public key is y=g^{x}.

The decentralized blockchain system 200 is advantageous as it enables easy verification of a solution to the problem, enables to adjust a difficulty of a problem easily, and enables a chance of solving the problem to be proportional to a computing power of the one or more miners 110A-N relative to the network's power. The problems in the problem mempool 108 are progress free and memoryless, i.e., no advantage is gained by previous attempts at finding a solution, and each attempt is equally probable to succeed. Thus, the number of attempts (or indirectly, the computational power) of a node or a computing device is an only factor relevant for success. In Bitcoin, as the solution has to be brute-force and because the hash is considered to be random, all the properties are satisfied. Further, a solution to one problem in a previous block cannot be reusable in another block of the decentralized blockchain system 200.

The problems in the problem mempool 108 may include (i) equiprobable solution space where all inputs given are equally to produce a valid solution, which is essential to maintain progress-freeness because if the solution space is skewed, fast one or more miners 110A-N can try out promising inputs first; (ii) inexhaustible solution space where the blockchain may not run out of problems to solve, (iii) non-algorithmically generated, and (iv) application-specific integrated circuit (ASIC) resistance that enables a general purpose computer too to solve the problem.

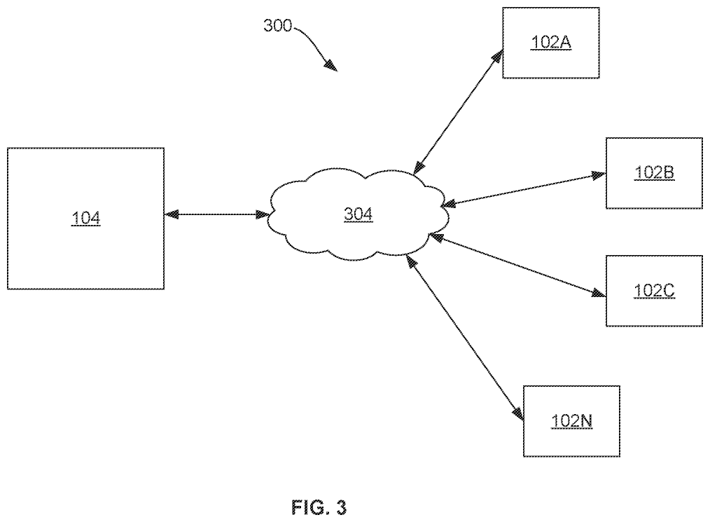

FIG. 3 illustrates a centralized blockchain system 300 for providing practically useful proof of work in blockchain mining according to an embodiment herein. The centralized blockchain system 300 includes a central server 104, and one or more computing devices 102A-N associated with of the one or more miners 110A-N. The one or more computing devices 102A-N is communicatively connected with each other in a peer-to-peer network. Each computing device 102A includes a memory and a processor that is configured to perform mining in the blockchain system 300. The one or more computing devices 102A-N may be a computer, a mobile terminal or any dedicated electronic device with a computing ability to solve a proposed problem. The central server 104 proposes a problem to be solved and sends the problem to the one or more computing devices 102A-N over a network 304. The one or more miners 110A-N in a blockchain network use a hash of a block header as an input and solve the proposed problem to mine a block in the blockchain network and claim a problem fee once the problem is solved.

In one exemplary embodiment, the problem is a univariate problem. A hash function H takes an input (i) and outputs hash h with n bits. The input is the block header of a block.
h=H(block header),
   where block header=(nonce∥previous hash∥Merkle root∥timestamp∥version) in a case of Bitcoin. Let f( ) be a real valued function in one variable such that for certain values of x, f(x)<y₀ for some real value y₀. The central server 104 is interested to find some xᵢ for which a condition f(xᵢ)<y₀ is satisfied. Any of the computing devices 102A-N may generate an output h with n bit as an integer/float value (similar to that of C programming language) from the hash function H. The computing device may then calculate f(h) and check whether f(h) is less than the threshold value y₀. If yes, the problem is considered solved, and the miner, using the computing device, publish the block. If no, the miner, using the computing device, proceeds to find a new h by picking a different nonce and repeating the above steps. Other one or more miners 110A-N or users of the blockchain may verify if the publisher solved the puzzle by computing H of the block and checking if the hash h does in fact give f(h)<y₀.

f(x) may be computed efficiently for all values of x in approximately at a same time, the solution for the problem may be easily verifiable as a hashing step may be done quickly. It may provide a proportional advantage to the one or more miners 110A-N as the one or more miners 110A-N may have to try out different nonces, and there is no progress if a hash fails to satisfy the condition, i.e., each nonce is equally likely to succeed in expectation.

The difficulty of the problem depends on a function and a target. The central server 104 estimates a time that the network may require to publish a block for a target y₀. In case central server 104 may require a much lower y₀ than is suitable for the blockchain, the central server 104 may set two targets that include y₁ for a regular functioning of the blockchain and y₀ for which the miner may be awarded additional reward. The same problem may be set again until a block achieves f(h)<y₀ as the output. This may be extended to solve a variety of problems.

In another exemplary embodiment, the problem is a multivariate problem. Consider y=fⁿ(x₁, . . . , xₙ)∈R. Let the acceptable subset of the range given by the central server 104 be Q. Any of the computing devices 102A-N derive an output (h) as k*n bit from the hash function (H). Then, the computing device divide the hash of the block (h) into n chunks of size k bits such that their concatenation is h. Alternatively, h=x₁*(2^{k})⁰+x₂*(2^{k})¹+ . . . xⁿ*(2^{k})ⁿ⁻¹. xᵢ's is considered as an input for a function ƒⁿ and the output is checked whether the output belongs to Q. If yes, the problem is considered as solved, and the miner may proceed to publish the newly created block. If no, the miner may proceed to find a new h by picking a different nonce and repeating the above steps. Other one or more miners 110A-N or users may simply verify if the publisher solved the problem by computing H of the block and checking if the hash h and the resulting xᵢ do in fact provide fⁿ(x₁ . . . xₙ) ∈Q.

In another exemplary embodiment, a problem is a task to find supernovae from high-resolution images. The data may be divided into 2^{k} small sectors. The one or more miners 110A-N may be informed of how to spot a supernova (either manually or computationally). Let hash h from H be of k bits. The computing device considers h as an integer value—the sector to be searched and then looks for a supernova in that sector. If supernova is found, then the miner publishes the block; else, try another sector with a different nonce. Other users or one or more miners 110A-N may verify by just looking at the sector given by the hash of the block. The miner may be rewarded more if a rarer object like, for instance, a magnetar is discovered.

Similarly, projects looking for gravitational waves (e.g., gravity spy), planets in other star systems (e.g., planet hunters) may use the blockchain system according to the embodiments herein. Changing the difficulty might be tough here, but a relationship between an overhead for every sector and sector size may be looked into to enable changing of difficulty by changing the size of each sector. Often such projects use simulated data to train and test the citizen scientists. This can also be used to adjust difficulty.

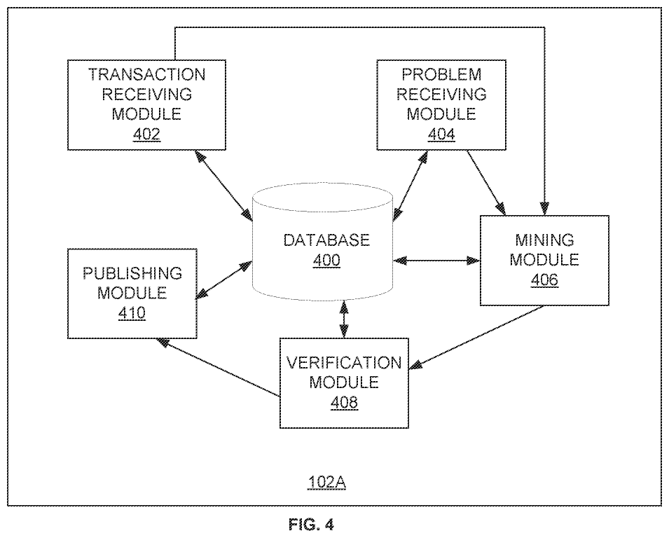

FIG. 4 is a block diagram that illustrates one or more modules of each of the computing devices 102A-N of the decentralized blockchain system 200 of FIG. 2 according to an embodiment herein. Each of the computing devices 102A-N includes a database 400 to store a blockchain, a transaction receiving module 402, a problem receiving module 404, a mining module 406, a verification module 408, and a publishing module 410. The transaction receiving module 402 is configured to receive one or more transactions from the transaction mempool 106 that are created by the one or more users 208A-N of the peer-to peer network to describe financial transactions or to provide other types of information. The problem receiving module 404 is configured to receive a plurality of problems from the problem mempool 108 that are proposed by the plurality of puzzlers 210A-N. Each problem includes a problem description, a timestamp, a difficulty level of a problem, a problem fee and a solution description. The plurality of puzzlers 110A-N may be any individual or any organization and stores the plurality of puzzles in the problem mempool 108 for solving by the one or more miners 110A-N. The mining module 406 is configured to create a new block by (i) selecting the one or more transactions that are received from the transaction mempool 106, (ii) selecting any problem that are received from the problem mempool 108, (iii) solving the problem using the computing power of the computing devices 102A-N as a proof of work, where hash of a block header is used as an input for the problem to be solved and (iv) broadcasting the created new block in the network for verification by other one or more miners 110A-N or users. The new block is created using the selected transactions and solution to the problem. The new block includes a block header and a block body. The block header may include a hash of a previous block, Merkle root of transactions, Merkle root of a new problem timestamp, nonce, version, and difficulty and hash of a problem solved. The block body may include transactions in Merkle tree, and a solution to the problem that is solved by the miner. The verification module 408 is configured to verify the problem solved by other one or more miners 110A-N. The verification module 408 is also configured to verify transactions in the data block. The publishing module 410 is configured to publish or update the new block in the blockchain 216 once the block is verified.

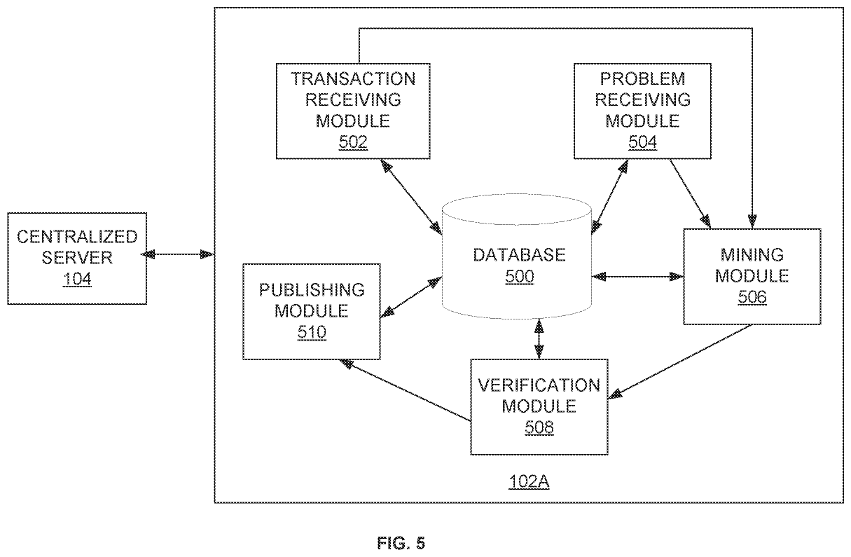

FIG. 5 is a block diagram that illustrates one or more modules of each of the computing devices 102A-N of the centralized blockchain system 300 of FIG. 3 according to an embodiment herein. Each of the computing device 102A-N includes a database 500 to store a blockchain, a transaction receiving module 502, a problem receiving module 504, a mining module 506, a verification module 508, and a publishing module 510. In some embodiments, the centralized server 104 communicates at least one transaction that corresponds to at least one miner, and at least one problem with a difficult calculation specification. The transaction receiving module 502 is configured to receive one or more transactions that are created by the one or more users of the peer-to peer network to describe financial transactions or to provide other types of information. The problem receiving module 504 is configured to receive at least one problem from the central server 104. Each problem includes a problem description, a timestamp, a difficulty level of a problem, a problem fee, and a solution description. The mining module 506 is configured to create a new block by (i) selecting one or more transactions, (ii) selecting the problem that is received from the central server 104, (iii) solving the problem using the computing power of the plurality of computing devices 102A-N as a proof of work, where hash of a block header is used as an input for the problem to be solved, and (iv) broadcasting the created new block in the network for verification by other one or more miners 110A-N or users. The new block is created using the selected transactions and solution to the problem. The new block includes a block header and a block body. The block header may include a hash of a previous block, Merkle root of transactions, Merkle root of a new problem timestamp, nonce, version, and difficulty and a hash of a problem solved. The block body may include transactions in Merkle tree, and a solution to the problem that is solved by the miner. The verification module 508 is configured to verify the problem solved by other one or more miners 110A-N. The verification module 508 is also configured to verify transactions. The publishing module 510A-N is configured to publish or update the new block in the blockchain 216 once the block is verified.

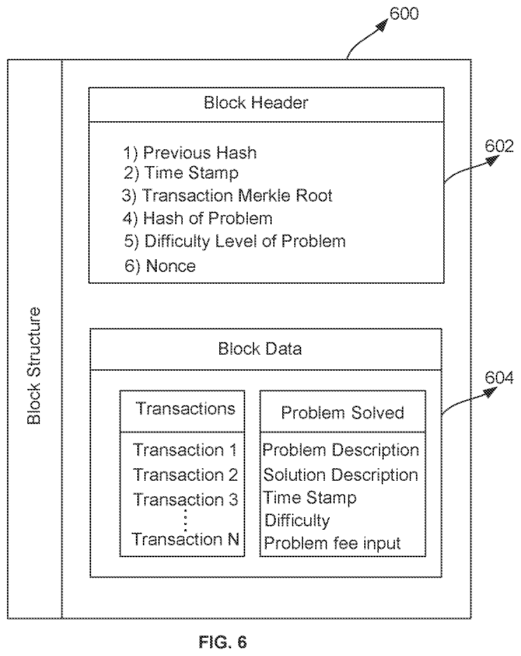

FIG. 6 illustrates an exemplary block 600 of a blockchain network according to an embodiment herein. The block 600 includes a block header 602 and a block body 604. The block header 602 includes at least one of(i) previous hash, 2) time stamp, 3) transaction Merkle root, 4) hash of problem, 5) difficulty level of problem, or 6) nonce. The block body 604 includes at least one of transactions or problem solved that includes problem description, solution description, time stamp, difficulty, and problem fee input.

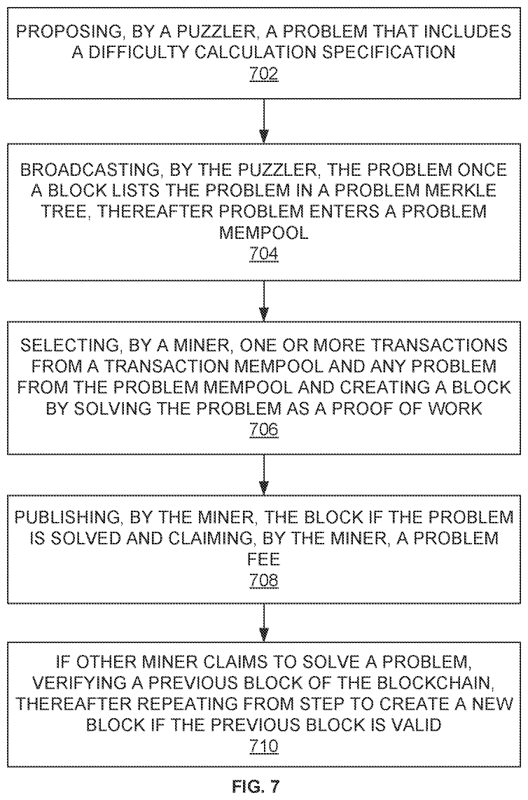

FIG. 7 illustrates a method for providing practically useful proof of work in a decentralized system for blockchain mining according to an embodiment herein. At step 702, a puzzler proposes a problem that includes a difficulty calculation specification. At step 704, the puzzler broadcasts the problem once a block lists the problem in a problem merkle tree, thereafter the problem enters a problem mempool. At step 706, the one or more miners 110A-N select one or more transactions from a transaction mempool and any problem from the problem mempool and create a block by solving the problem as a proof of work. At step 708, if the problem is solved, the block is published by the miner and the miner claims a problem fee. At step 710, if other miner claims to solve the problem, a previous block of the block chain is verified thereafter steps 706-708 are repeated to create a new block if the previous block is valid.

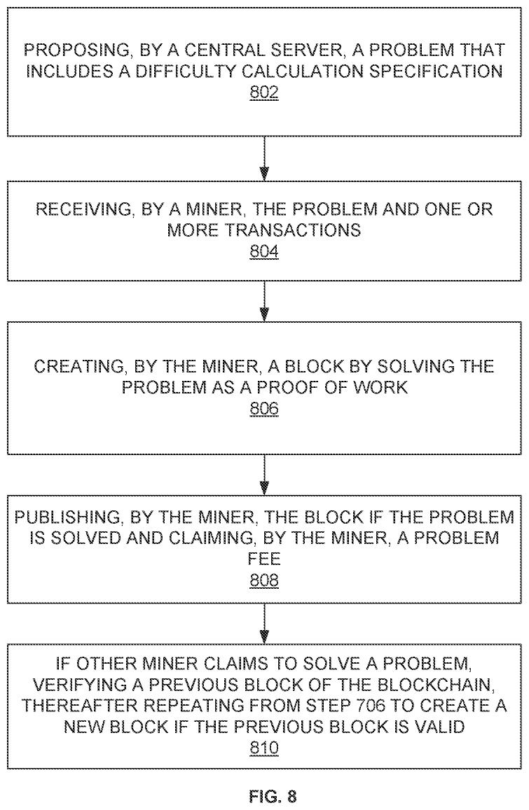

FIG. 8 illustrates a method for providing practically useful proof of work in a centralized system for blockchain mining according to an embodiment herein. At step 802, a central server proposes a problem that includes a difficulty calculation specification. At step 804, a miner receives the problem and one or more transactions. At step 806, the miner creates a block by solving the problem as a proof of work. At step 808, if the problem is solved, the block is published by the miner and the miner claims a problem fee. At step 810, if other miner claims to solve the problem, a block of the other miner is verified thereafter steps 806 to 808 are repeated to create a new block if block of the other miner is valid.

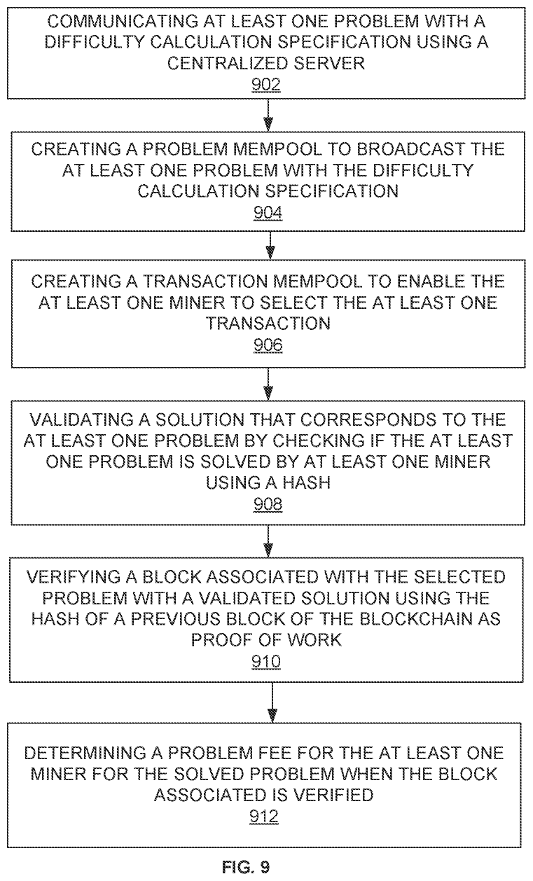

FIG. 9 illustrates a method for better utilization of power consumption of a computing network in at least one blockchain system by validating digital currency transactions with minimal computing resources according to an embodiment herein. At step 902, at least one problem with a difficulty calculation specification is communicated using a centralized server. The centralized server communicates at least one transaction that corresponds to at least one miner. At step 904, a problem mempool is created to broadcast the at least one problem with the difficulty calculation specification. At step 906, a transaction mempool is created to enable the at least one miner to select the at least one transaction. At step 908, a solution that corresponds to the at least one problem is validated by checking if the at least one problem is solved by at least one miner using a hash. At step 910, a block associated with the selected problem with a validated solution is verified using the hash of a previous block of the blockchain as proof of work. At step 912, a problem fee is determined for the at least one miner for the solved problem when the block associated is verified. The at least one problem is entered into the problem mempool once a problem is registered in a problem merkle tree. The selected problem is communicated to the at least one miner using at least one of the centralized server, a problem mempool or a transactional mempool.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

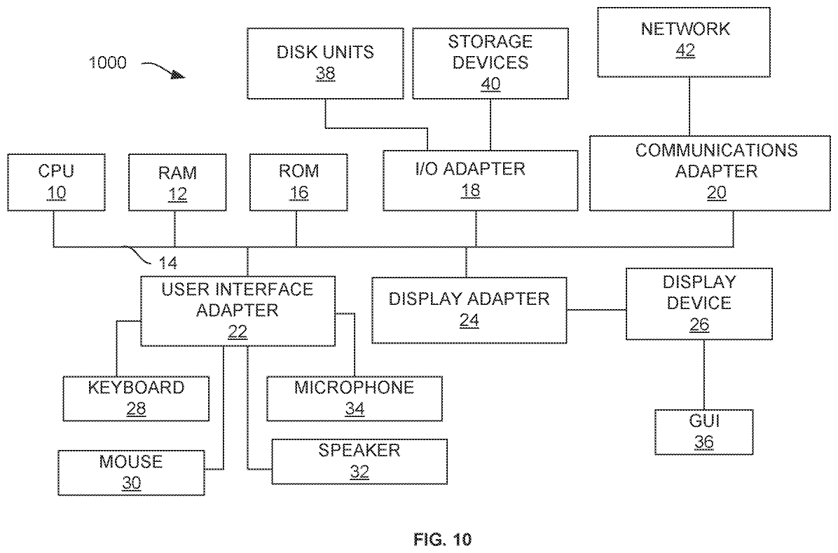

FIG. 10 is a schematic diagram of computer architecture of a computing device 1000, in accordance with the embodiments herein. A representative hardware environment for practicing the embodiments herein is depicted in FIG. 10, with reference to FIGS. 1 through 9.

This schematic drawing illustrates a hardware configuration of a server/computer system/computing device/user device in accordance with the embodiments herein. The system 100, 200 or 300 of FIG. 1 may use the computing device for providing practically useful proof of work in blockchain mining according to the embodiments herein. The computing device 1000 includes at least one processing device CPU 10 that may be interconnected via system bus 14 to various devices such as a random-access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents employed herein is for the purpose of description and not of limitation. Therefore, while the embodiments herein have been described in terms of preferred embodiments, those skilled in the art will recognize that the embodiments herein can be practiced with modification within the scope of the appended claims.

What is claimed is:

1. A system for better utilization of power consumption of a computing network in at least one blockchain system by validating digital currency transactions with minimal computing resources, comprising,
a memory;
a processor that is configured to
communicate at least one problem with a difficulty calculation specification using a centralized server, wherein the centralized server communicates at least one transaction that corresponds to at least one miner;
create a problem mempool to broadcast the at least one problem with the difficulty calculation specification, wherein the at least one problem is entered into the problem mempool once a problem is registered in a problem merkle tree;
create a transaction mempool to enable the at least one miner to select the at least one transaction;
validate a solution that corresponds to the at least one problem by checking if the at least one problem is solved by at least one miner using a hash, wherein the selected problem is communicated to the at least one miner using at least one of the centralized server, the problem mempool or the transactional mempool;
verify a block associated with the selected problem with a validated solution using the hash of a previous block of a blockchain as a proof of work; and
determine a problem fee for the at least one miner for the solved problem when the block associated is verified.

2. The system of claim 1, wherein the centralized server is utilized for a centralized blockchain system to communicate the at least one problem with the difficulty calculation specification.

3. The system of claim 1, wherein the problem mempool and the transaction mempool are created for a decentralized blockchain system to broadcast the at least one problem with the difficulty calculation specification.

4. The system of claim 1, wherein the transaction mempool comprises valid pending transactions that are added to be in the blockchain.

5. The system of claim 1, wherein the at least one problem are cryptographic puzzles that are communicated to the at least one miner using the centralized server by at least one puzzler, wherein each problem includes a problem description, a timestamp, a difficulty level of a problem, a problem fee and a solution description.

6. The system of claim 1, wherein the system is communicatively connected with a plurality of computing devices that are associated with the at least one miner to solve the at least one problem, wherein each computing device stores the blockchain.

7. The system of claim 1, wherein each block of the blockchain comprise at least one of
a block header or a block body, wherein the block header comprises
at least one of a hash of a previous data block, Merkle root of transactions, a Merkle root of a new problem timestamp, a nonce, a version, or a difficulty and a hash of a problem solved,
wherein the block body comprises
at least one transaction in Merkle tree, or the problem that is solved by the at least one miner of the plurality of miners.

8. The system of claim 1, wherein the at least one miner solves a cryptographic puzzle as the proof of the work in an absence of problems in the problem mempool to solve.

9. The system of claim 1, wherein the problems in the problem mempool comprise at least one of
(i) equiprobable solution space where inputs given are equally to produce a valid solution, which is to be maintained progress-freeness because if a solution space is skewed, the at least one miner is try out promising inputs first;
(ii) inexhaustible solution space where the blockchain does not run out of problems to solve;
(iii) non-algorithmically generated; or
(iv) application-specific integrated circuit (ASIC) resistance that enables a general-purpose computer too to solve the problem.

10. The system of claim 1, wherein the at least one miner publishes the solution as a proof of work block for the at least one problem that is selected and solved to claim the problem fee.

11. A method for better utilization of power consumption of a computing network in at least one blockchain system by validating digital currency transactions with minimal computing resources, comprising,
communicating at least one problem with a difficulty calculation specification using a centralized server, wherein the centralized server communicates at least one transaction that corresponds to at least one miner;
creating a problem mempool to broadcast the at least one problem with the difficulty calculation specification, wherein the at least one problem is entered into the problem mempool once a problem is registered in a problem merkle tree;
creating a transaction mempool to enable the at least one miner to select the at least one transaction;
validating a solution that corresponds to the at least one problem by checking if the at least one problem is solved by at least one miner using a hash, wherein the selected problem is communicated to the at least one miner using at least one of the centralized server, a problem mempool or a transactional mempool;
verifying a block associated with the selected problem with a validated solution using the hash of a previous block of the blockchain as proof of work; and
determining a problem fee for the at least one miner for the solved problem when the block associated is verified.

12. The method of claim 11, wherein the method comprises utilizing the centralized server for a centralized blockchain system to communicate the at least one problem with the difficulty calculation specification.

13. The method of claim 11, wherein the method comprises creating the problem mempool and the transaction mempool for a decentralized blockchain system to broadcast the at least one problem with the difficulty calculation specification, wherein the transaction mempool comprises valid pending transactions that are added to be in the blockchain.

14. The method of claim 11, wherein the method comprises communicating at least one problem are cryptographic puzzles to the at least one miner using the centralized server by at least one puzzler, wherein each problem comprises a problem description, a timestamp, a difficulty level of a problem, a problem fee and a solution description.

15. The method of claim 11, wherein the method comprises
solving a cryptographic puzzle by the at least one miners as the proof of the work in an absence of problems in the problem mempool to solve; and
publishing the solution by the at least one miner as a proof of work block for the at least one problem that is selected and solved to claim the problem fee.

16. One or more non-transitory computer-readable storage mediums storing the one or more sequences of instructions, which when executed by one or more processors, further causes a method for better utilization of power consumption of a computing network in at least one blockchain system by validating digital currency transactions with minimal computing resources, comprising,
communicating at least one problem with a difficulty calculation specification using a centralized server, wherein the centralized server communicates at least one transaction that corresponds to at least one miner;
creating a problem mempool to broadcast the at least one problem with the difficulty calculation specification, wherein the at least one problem is entered into the problem mempool once a problem is registered in a problem merkle tree;
creating a transaction mempool to enable the at least one miner to select the at least one transaction;
validating a solution that corresponds to the at least one problem by checking if the at least one problem is solved by at least one miner using a hash, wherein the selected problem is communicated to the at least one miner using at least one of the centralized server, a problem mempool or a transactional mempool;
verifying a block associated with the selected problem with a validated solution using the hash of a previous block of the blockchain as proof of work; and
determining a problem fee for the at least one miner for the solved problem when the block associated is verified.

17. The one or more non-transitory computer-readable storage mediums storing the one or more sequences of instructions of claim 16, wherein the method comprises utilizing the centralized server for a centralized blockchain system to communicate the at least one problem with the difficulty calculation specification.

18. The one or more non-transitory computer-readable storage mediums storing the one or more sequences of instructions of claim 16, wherein the method comprises creating the problem mempool and the transaction mempool for a decentralized blockchain system to broadcast the at least one problem with the difficulty calculation specification, wherein the transaction mempool comprises valid pending transactions that are added to be in the blockchain.

19. The one or more non-transitory computer-readable storage mediums storing the one or more sequences of instructions of claim 16, wherein the method comprises communicating at least one problem are cryptographic puzzles to the at least one miner using the centralized server by at least one puzzler, wherein each problem comprises a problem description, a timestamp, a difficulty level of a problem, a problem fee and a solution description.

20. The one or more non-transitory computer-readable storage mediums storing the one or more sequences of instructions of claim 16, wherein the method comprises
solving a cryptographic puzzle by the at least one miners as the proof of the work in an absence of problems in the problem mempool to solve; and
publishing the solution by the at least one miner as a proof of work block for the at least one problem that is selected and solved to claim the problem fee.
